(19) United States
(12) Patent Application Publication
(10) Pub. No.: US 2016/0155097 A1
(43) Pub. Date: Jun. 2, 2016

(54) REPORTS OF REPAIRABLE OBJECTS AND EVENTS

(71) Applicant: EBAY INC., San Jose, CA (US)

(72) Inventor: Harsha Mysore Vinayak Venkatesha, La Vista, NE (US)

(21) Appl. No.: 14/557,889

(22) Filed: Dec. 2, 2014

(51) Int. Cl. G06Q 10/00

(52) U.S. Cl. CPC G06Q 10/20

(57) ABSTRACT

Disclosed are systems, mediums, and methods for determining reports of repairable objects and events. A processing module of a server device accesses data packets from one or more client devices, where the data packets include multimedia data indicative of a repairable object. A diagnostics module of the server device identifies from the multimedia data details of one or more damaged portions of the repairable object, where the diagnostics module further determines instructions to repair the one or more damaged portions, and where the diagnostics module further selects an entity to repair the repairable object based at least on the details of the one or more damaged portions. A reporting module of the server device determines a report for the entity selected to repair the repairable object, where the report includes the details of the one or more damaged portions and the instructions to repair the one or more damaged portions. A communication module of the server device that sends the report to a client device of the entity selected to repair the object.

### TECHNICAL FIELD

This disclosure generally relates to electronic reporting, and more particularly, to devices configured to determine reports of repairable objects and/or events.

### BACKGROUND

Various aspects of a city or town may require inspections and maintenance. In some instances, a city may require regular inspections and maintenance of its structures, buildings, and/or objects to ensure the preservation of the city and to maintain safety within the city. For example, the city may require regular inspections of its power lines, traffic signals, and/or street conditions, among other possibly aspects of the city. Such inspections may increase safety in the city, facilitate the accessibility to power, and/or maintain the traffic flow in the city, among other possible benefits. In some instances, various aspects of the city may require detailed inspections to identify signs of aging, damages, and/or causes of the damages. Yet, with the growing of the city, an increasing number of people residing in the city, a limited number of city employees, and the passage of time, the efforts to inspect and maintain the city may increase dramatically.

### BRIEF DESCRIPTION OF THE DRAWINGS

FIG. 1 is a simplified block diagram of an reporting example system, according to an embodiment;

FIG. 2A is an exemplary server device configured to support a set of trays, according to an embodiment;

FIG. 2B is an exemplary tray configured to support one or more modules/components, according to an embodiment;

FIG. 3 illustrates an exemplary client device, according to an embodiment;

FIG. 4 illustrates another exemplary a client device, according to an embodiment;

FIG. 5 illustrates yet another exemplary client device, according to an embodiment;

FIG. 6 is a flowchart of an exemplary method, according to an embodiment; and

FIG. 7 illustrates yet another exemplary client device, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

As a general matter, there is a growing need for regularly inspecting structures, buildings, objects, and/or other aspects of a city or town. Along with this growing need, computing devices are also becoming increasingly more prevalent. In some instances, a single user may own and/or operate a camera phone, a tablet computer, and a personal computer device, among other possible computing devices. In one example, consider an individual passing by a broken line, e.g., a broken telephone line and/or a power line. The individual may discover the broken line and operate a camera phone to capture an image of the broken line. Further, the individual may send the image to a local utility company that may investigate the broken line and repair the damages to the broken line.

Further, consider multiple camera phones capturing images and/or videos of a monument proximately located to the broken line, possibly indicating a location of the broken line. As such, various forms of multimedia data, e.g., image data, sound data, and/or audiovisual data, may capture additional details of broken line, possibly shown in the background of the images of the monument. In some instances, the multimedia data captured from the various phones may be analyzed. For example, the multimedia data may be combined through image/photo stitching, pixel merging, and image overlapping, among other types of image processing schemes for combining multimedia data. As such, various details of the broken line may be analyzed and inspected to identify damages that may require maintenance and/or repairs.

In some embodiments, the multimedia data may be represented by data and/or packets of data, possibly referred to as “data packets.” In some instances, a server device may manage, parse, and/or construct and deconstruct such data and/or data packets, among other steps to analyze data. In particular, the server device may identify that the data and/or data packets include multimedia data indicative of a repairable object. For example, the server device may receive and/or access data packets from one or more client devices, e.g., a camera phone, a wearable computing device, and/or another portable communication device, among other client devices configured to capture multimedia data of the repairable object. Further, the server device may identify that the data and/or the data packets include multimedia data that indicates details of the repairable object. Yet further, the server may inform various entities regarding the details of the repairable object, possibly sending the details to one or more client devices of the various entities. More generally, image and/or audio data may be captured by a user device, along with location information. Further, the data may be manually or automatically routed to an appropriate entity or person to take and/or engage in a suitable course of action, such as an inspection, maintenance, a repair, a rescue, and/or other actions.

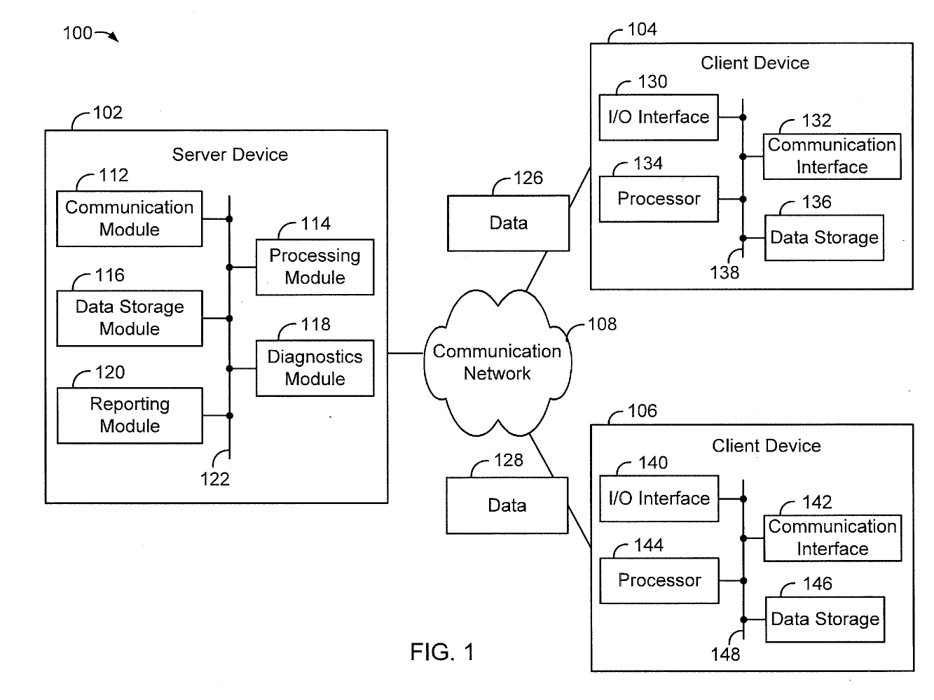

FIG. 1 is a simplified block diagram of an example reporting system 100, according to an embodiment. As shown, the reporting system 100 includes multiple computing devices, namely a server device 102, a client device 104, also referred to as a first client device 104, and a client device 106, also referred to as a second client device 106. The server device 102 may be configured to manage, parse, and/or construct and deconstruct data packets that include various types of data such as multimedia data. Further, also included in the reporting system 100 is a communication network 108. The reporting system 100 may operate with more or less than the computing devices shown in FIG. 1, possibly communicating with each device via a communication network 108. Generally, server device 102, client device 104, and client device 106 are configured for communicating with each other via the communication network 108.

The communication network 108 may be a data network, a switch network, and/or a packet-switched, and/or another network configured to provide digital networking communications and exchange data of various forms, content, type, and/or structure. Communication network 108 may correspond to small scale communication networks, such as a private or local area network, or a larger scale network, such as a wide area network or the Internet, possibly accessible by the various components of system 100. Communication network may include network adapters, switches, routers, network nodes, and various buffers and queues to exchange data packets and various forms of data. For example, communication network 108 may be configured to carry data packets such as data and/or data packet 126 and data and/or data packet 128. Communication network 108 may exchange such data between server device 102, client device 104, and client device 106 using various protocols such as Transmission Control Protocol/Internet Protocol (TCP/IP), among other possibilities.

The reporting system 100 may also include other computing devices or implement software components that operate to perform various methodologies in accordance with the described embodiments. For example, the reporting system 100 may include other client devices, stand-alone and/or enterprise-class servers possibly implementing MICROSOFT®, UNIX®, LINUX®, and other client- and server-based operating systems, among other types of operating systems. It may be appreciated that the client devices and server devices illustrated in FIG. 1 may be deployed in other ways. The operations performed and the services provided by such client devices and server devices may be combined or separated for a given embodiment. Further, such operations and servers may be performed by a greater number or a fewer number of devices and/or server devices. One or more devices and servers devices may be operated and maintained by the same or different entities.

The server device 102 may be configured to perform a variety of functions, such as those described in this disclosure and illustrated by the accompanying figures. For example, the server device 102 may be configured to access and/or receive data packets that include multimedia data indicative of a repairable object. Further, the server device 102 may access and/or receive the data packets from network nodes, network adapters, switches, routers, and/or various buffers and queues of the communication network 108. Yet further, server device 102 may receive the data packets from the client devices 104 and 106. In some instances, the server device 102 may store the data packets in the data storage module 116. Further, the server device 102 may access the multimedia data from the data storage module, among other possibilities to access the data packets.

The server device 102 may take a variety of forms and may include various components, including for example, a communication module 112, a processing module 114, a data storage module 116, a diagnostics module 118, and a reporting module 120, any of which may be communicatively linked to the other modules via a system bus, network, or other connection mechanism 122.

The communication module/component 112 may take a variety of forms and may be configured to allow the server device 102 to communicate with one or more devices according to various protocols. For instance, communication module 112 may be configured to allow server device 102 to communicate with client devices 104 and/or 106 via communication network 108. In one example, communication module 112 may take the form of a wired interface, such as an Ethernet interface. As another example, communication module 112 may take the form of a wireless interface, such as a cellular interface, a WI-FI interface, a short-range interface, a point-to-multipoint voice interface, and/or a data transfer communication interface. For instance, communication module may take the form of a short-range radio frequency interface for mobile devices and Local Areas Network (LAN) access points for digital transmission over the 2.4 GHz bandwidth such as BLUETOOTH.

In some instances, the communication module/component 112 may receive, access, and/or send data packets that include multimedia data indicative of a repairable object and/or an actionable event. For example, the communication module 112 may access the data packets from network nodes, network adapters, switches, routers, and/or various buffers and queues of the communication network 108. Yet further, server device 102 may transmit, receive, and/or access the data packets from the client devices, among other possibilities to exchange the data packets.

The processing module/component 114 may include or take the form of a general purpose processor (e.g., a microprocessor). Further, the processing module/component 114 may include or take the form of a processing component and/or a special purpose processor such as a digital signal processor (DSP). As such, the processing module/component 114 may access the data and/or data packet 126 from the client device 104. Further, processing module/component 114 may access the data and/or data packet 128 from the client device 106. For example, the data packet 126 and the data packet 128 may travel over communication network 108. Further, the data packets 126 and 128 may include IP addresses of client device 104 and 106, respectively. Yet further, the data packets 126 and 128 may also include protocol data such as Transmission Control Protocol/Internet Protocol (TCP/IP). In various embodiments, each of the data packets 126 and 128 may include 1,000 to 1,500 bytes, among other possible ranges.

The data storage module/component 116 may include one or more volatile, non-volatile, removable, and/or non-removable storage components, such as magnetic, optical, or flash storage, and may be integrated in whole or in part with processing module/component 114. Further, the data storage module 116 may include or take the form of a non-transitory computer-readable storage medium, having stored thereon machine-readable instructions, e.g., compiled or non-compiled program logic and/or machine code. In some instances, the instructions may be executed by the modules/components 112-118, that may take the form of hardware modules/components of server device 102. Further, the instructions may cause the server device 102 to perform operations, such as those described in this disclosure and illustrated by the accompanying figures.

The diagnostics module/component 118 may identify from the multimedia data details of one or more damaged portions of a repairable object. Further, the diagnostics module/component 118 may identify such details from image data, sound data, and/or audiovisual data, among other forms of data. Yet further, the diagnostics module/component 118 may be configured to implement image recognition, object recognition, and/or pattern recognition, among other types of computer vision technology to identify the details from the image data. In some instances, the diagnostics module/component 118 may identify various street conditions from the image data. For example, the diagnostics module 118 may identify a pothole, a crack, and/or a crevice in a street, and/or other irregularities that may affect safe traffic in a city. Further, the diagnostics module 118 may compare the image data with other forms image data to identify the irregularities. In particular, the diagnostics module 118 may compare recent images of the street with prior images of the street to determine the irregularities in the street, among other examples.

Further, the diagnostics module/component 118 may determine instructions to repair the one or more damaged portions of an object. For example, considering the examples described above, the diagnostics module 118 may identify a pothole in the street and determine the size, shape, and/or depth of the pothole. As such, the diagnostics module 118 may determine the instructions to repair the street by filling the pothole. In particular, the diagnostics module 118 may determine instructions to fill the pothole with concrete, asphalt, and/or blacktop, and/or other mixing or filling materials. Yet further, the diagnostics module 118 may determine the types of tools that may be used to repair the street.

In some instances, the diagnostics module/component 118 may select an entity to repair the repairable object based at least on the details of the one or more damaged portions. In some instances, the diagnostics module/component 118 may determine the entity based at least on the details of the one or more damaged portions, possibly indicating the severity of the damaged portions. For example, considering the examples described above, the diagnostics module/component 118 may determine the entity based on the size, shape, and/or depth of the pothole, among other possible characteristics of the pothole. As such, the diagnostics module/component 118 may determine the entity to be a street maintenance facility, a fire department, and/or a police department, among other types of public service entities. In addition, the diagnostics module/component 118 may determine the entity to be a person, one or more persons, a robotic device, one or more robotic devices, among other entities capable of carrying out the instructions.

In some embodiments, the entity may be associated with an account, possibly to be compensated for carrying out the instructions. For example, the entity may be registered with an account and possibly trained, licensed, qualified, and/or certified to carry out instructions determined by the diagnostics module/component 118. As such, the entity may be compensated for repairing objects through the entity's account. For example, an entity, e.g., a person and/or a robot device, may be trained to repair potholes in the roads of a city. As such, the entity may carry out the instructions determined by the diagnostics module 118 to repair the pothole, possibly creating a market for various entities to fix repairs and/or provide services in a city or town.

The diagnostics module/component 118 may include one or more general purpose processors, microprocessors, and/or one or more special purpose processors such as a digital signal processor (DSP), a graphics processing unit (GPU), a floating point unit (FPU), a network processor, and/or an application-specific integrated circuit (ASIC). In some instances, special purpose processors may be capable of image processing, image alignment, and/or merging images, among other possibilities. The diagnostics module/component 118 may include components, pre-configured circuits, dedicated circuits, and/or hardware components of the server device 102. Further, the diagnostics module 118 may include circuits and/or hardware components that are configured to carry out one or more operations described in this disclosure and illustrated by the accompanying figures. For example, the diagnostics module 118 may identify from the data packet 126 multimedia data with details of one or more damaged portions of a repairable object. Yet further, diagnostics module 118 may determine from the data packet 128 additional details of the other damaged portions of the repairable object.

The reporting module/component 120 may determine a report for the entity selected to repair the repairable object. Further, the report may also include the details of the one or more damaged portions and the instructions to repair the one or more damaged portions. The reporting module/component 120 may include one or more general purpose processors, e.g., microprocessors, and/or one or more special purpose processors, e.g., DSPs, graphics GPUs, FPUs, network processors, or ASICs. Further, the reporting module/component 120 may include components, pre-configured circuits, dedicated circuits, and/or hardware components of the server device 102. In addition, the reporting module/component 120 may include circuits and/or hardware components that are configured to carry out one or more operations described in this disclosure and illustrated by the accompanying figures.

As such, in some embodiments, the reporting system 100 may include the processing module 114 of the server device 102 that accesses the data packets 126 and 128 from the client device 104. The data packets 126 and 128 may include multimedia data indicative of a repairable object. Further, the diagnostics module 118 of the server device 102 may identify from the multimedia data details of one or more damaged portions of the repairable object. Yet further, the diagnostics module 118 may further determine instructions to repair the one or more damaged portions. In addition, the diagnostics module 118 may further select an entity to repair the repairable object based at least on the details of the one or more damaged portions. Further, the reporting module 120 of the server device may determine a report for the entity selected to repair the repairable object. Yet further, the report may include the details of the one or more damaged portions and the instructions to repair the one or more damaged portions. In addition, the communication module 112 of the server device 102 may send the report to the client device 106 of the entity selected to repair the object.

As with server device 102, client devices 104 and 106 may be configured to perform a variety of operations such as those described in this disclosure. For example, client devices 104 and 106 may be configured to exchange, send, and/or receive data packets from the server device 102 such as data packets 126 and 128 including multimedia data indicative of a repairable object.

The client devices 104 and 106 may take a variety of forms, including for example, a personal computer (PC), a smart phone, a laptop/tablet computer, a wearable computing device, a smart watch, and/or a head-mountable display/device, among other types of computing devices capable of transmitting and/or receiving data. Further, client devices 104 and 106 may take the form of an unmanned aerial vehicle (UAV), a drone device, a robotic device, a device capable of taking flight, and/or other types of mobile devices capable of transmitting and/or receiving data. The client devices 104 and 106 may include various components including I/O interfaces 130 and 140, communication interfaces 132 and 142, processors 134 and 144, and data storages 136 and 146, respectively, all of which may be communicatively linked with each other via a system bus, network, or other connection mechanisms 138 and 148, respectively.

The I/O interfaces 130 and 140 may be configured for facilitating interaction between client devices 104 and 106 and users of client devices 104 and 106, possibly capturing multimedia data indicative of one or more repairable objects. For example, I/O interfaces 130 and 140 may be configured to capture image data, sound data, and/or audiovisual data, among other possible forms of multimedia data. As such, I/O interfaces 130 and 140 may include input components such as a camera, a camera configured to capture audiovisual data, a microphone configured to capture sound data, and/or other input devices configured to capture multimedia data. Further, I/O interfaces 130 and 140 may include computer mouse, a keyboard, and/or a touch sensitive panel. In addition, I/O interfaces 130 and 140 may include output components such as display screens which, for example, may be combined with a touch sensitive panel, a sound speaker or other audio output mechanism, and a haptic feedback system.

Communication interfaces 132 and 142 may take a variety of forms and may be configured to allow client devices 104 and 106 to communicate with one or more devices according to any number of protocols. For instance, communication interfaces 132 and 142 may be configured to allow client devices 104 and 106, respectively, to communicate with the server device 102 via the communication network 108. As noted, the communication module 112 may take the form of a wired or wireless interface to facilitate the communication with client devices 104 and 106.

Processors 134 and 144 may include general purpose processors and/or special purpose processors. Data storages 136 and 146 may include one or more volatile, non-volatile, removable, and/or non-removable storage components, and may be integrated in whole or in part with processors 134 and 144, respectively. Further, data storages 136 and 146 may take the form of non-transitory computer-readable storage mediums, having stored thereon machine-readable instructions that, when executed by processors 134 and 144, cause client devices 104 and 106 to perform operations, respectively, such as those described in this disclosure and illustrated by the accompanying figures. Such machine-readable instructions may define or be part of a discrete software application, such a native app or web app that can be executed upon user request for instance.

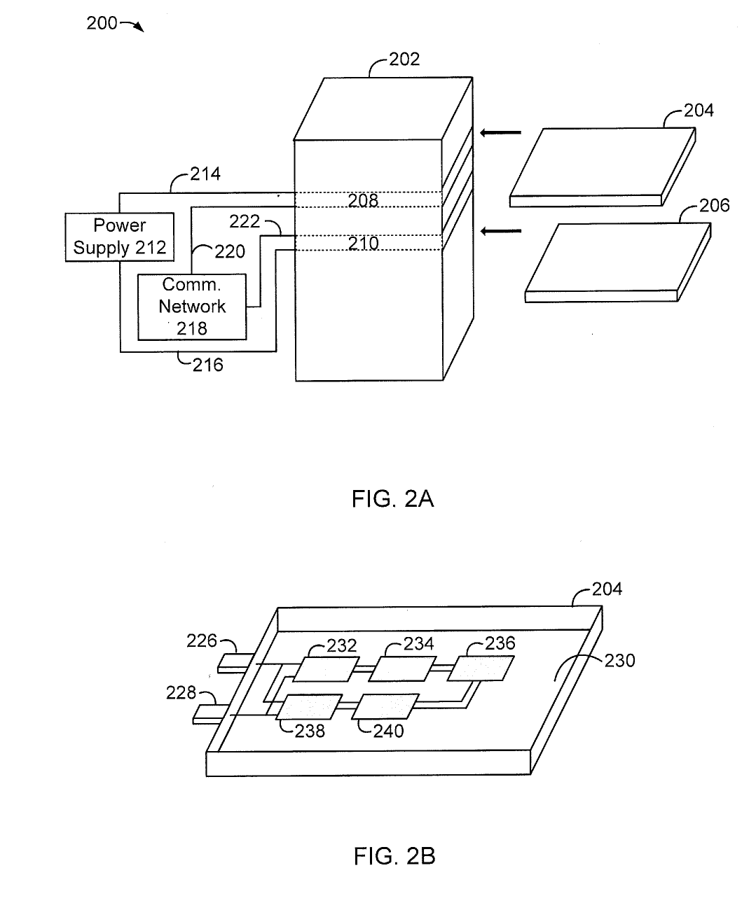

FIG. 2A is an exemplary server device 200 configured to support a set of trays, according to an embodiment. Server device 200 may, for example, take the form of server device 102 described above in relation to FIG. 1. Further, server device 200 may be configured to carry out the operations described above in relation to FIG. 1. For example, the server device 200 may be configured to manage, parse, and/or construct and deconstruct data and/or data packets that include various types of data such as multimedia data.

As shown, the server device 200 may include a chassis 202 that may support trays 204 and 206, and possibly multiple other trays as well. The chassis 202 may include slots 208 and 210 configured to hold the trays 204 and 206, respectively. For example, the tray 204 may be inserted into the slot 208 and the tray 206 may be inserted into the slot 210. Yet, the slots 208 and 210 may be configured to hold the trays 204 and 206 interchangeably such that the slot 208 may be configured to hold the tray 206 and the slot 210 may be configured to hold the tray 204. For example, the tray 204 may be inserted into the slot 208 and the tray 206 may be inserted into the slot 210. Further, during operation of the server device 200, the trays 204 and 206 may be removed from the slots 208 and 210, respectively, and the tray 204 may be inserted into the slot 210 and the tray 206 may be inserted into slot the 208. Yet further, the trays 204 and 206 may continue operating with the server device 200.

The chassis 202 may be connected to a power supply 212 via connections 214 and 216 to supply power to slots 208 and 210, respectively. Chassis 202 may also be connected to communication network 218 via connections 220 and 222 to provide network connectivity to each of slots 208 and 210, respectively. As such, trays 204 and 206 may be inserted into slots 208 and 210, respectively, and power supply 212 may supply power to trays 204 and 206 via connections 214 and 216, respectively. Further, trays 204 and 206 may be inserted into slots 210 and 208, respectively, and power supply 212 may supply power to trays 204 and 206 via connections 216 and 214, respectively.

Yet further, trays 204 and 206 may be inserted into slots 208 and 210, respectively, and communication network 218 may provide network connectivity to trays 204 and 206 via connections 220 and 222, respectively. In addition, trays 204 and 206 may be inserted into slots 210 and 208, respectively, and communication network 218 may provide network connectivity to trays 204 and 206 via connections 222 and 220, respectively.

Communication network 218 may, for example, take the form of communication network 108 described above in relation to FIG. 1. In some embodiments, communication network 218 may provide a network port, a network hub, a network switch, or a network router that may be connected to a telephone, Ethernet, or an optical communication link, among other communication mechanisms.

FIG. 2B is an exemplary tray 204 configured to support one or more modules/components, according to an embodiment. The tray 204 may, for example, take the form of the tray 204 described in relation to FIG. 2A. Further, the tray 206 in FIG. 2A may also take the form of the tray 204. As shown, the tray 204 may include the tray base 230 that may be the bottom surface of the tray 204 configured to support multiple components such as a main computing board that may connect one or more other modules/components. The tray 204 may include a connector 226 that may link to the connections 214 or 216 to supply power to the tray 204. The tray 204 may also include a connector 228 that may link to the connections 220 or 222 to provide network connectivity to the tray 204. The connectors 226 and 228 may be positioned on the tray 204 such that upon inserting the tray 204 into the slot 208, the connectors 226 and 228 may couple directly with connections 214 and 220, respectively. Further, upon inserting tray 204 into slot 210, connectors 226 and 228 may couple directly with connections 216 and 222, respectively.

Tray 204 may include modules/components 232-240. In some instances, a communication module/component 232, a processing module/component 234, a data storage module/component 236, a diagnostics module/component 238, and a reporting module/component 240 may, for example, take the form of the communication module/component 112, the processing module/component 114, the data storage module/component 116, the diagnostics module/component 118, and the reporting module 120, respectively. As such, tray 204 may provide power and network connectivity to each of modules/components 232-240. In some embodiments, one or more of the modules/components 232-240 may take the form of one or more components and/or circuits that include resistors, inductors, capacitors, voltage sources, current sources, switches, logic gates, registers, and/or a variety of other circuit elements. One or more of the components in a circuit may be configured to cause one or more of the modules/components 232-240 to perform the operations described herein. As such, in some embodiments, preconfigured and dedicated circuits may be implemented to perform the operations. In other embodiments, a processing system may execute instructions on a non-transitory, computer-readable medium to configure the one or more circuits to perform the operations of the modules/components 232-240.

Any of the modules/components 232-240 may be combined to take the form of one or more general purpose processors, microprocessors, and/or special purpose processors, among other types of processors. For example, the diagnostics module/component 238 and the reporting module/component 240 may be combined with the processing module/component 234, possibly such that the diagnostics module/component 238 and the reporting module/component 240 are combined and/or embedded within the processing module 234. Further, the combined processing module 234 may take the form of one or more DSPs, graphics GPUs, FPUs, network processors, and/or ASICs. Yet further, the combined processing module 234 may be configured to implement the operations carried out by the diagnostics module 238 and the reporting module 240.

In some embodiments, the server device 200 may include a non-transitory computer-readable medium as described above in relation to FIGS. 1-2B. In some instances, the medium may have stored thereon machine-readable instructions that, when executed by any of hardware modules 232-240 of the server device 200, cause performance of operations. For example, the operations may include accessing, by the processing module 234 of the hardware modules 232-240, data from one or more client devices, where the data comprises multimedia data indicative of a repairable object. Further, the operations may include identifying, by the diagnostics module 238 of the hardware modules 232-240, details of the repairable object from the multimedia data, where the details indicate one or more damaged portions of the repairable object. Yet further, the operations may include determining, by the diagnostics module 238, instructions to repair the one or more damaged portions, where the instructions comprise an indication of one or more tools required to carry out the instructions. In addition, the operations may include determining, by the reporting module 240, a report for one or more entities to repair the one or more damaged portions, where the report includes the instructions to repair the one or more damaged portions. Yet further, the operations may include sending, by the communication module 232 of the one or more hardware modules 232, the report to the entity. It should be noted that the operations may be performed by the hardware components 232-240.

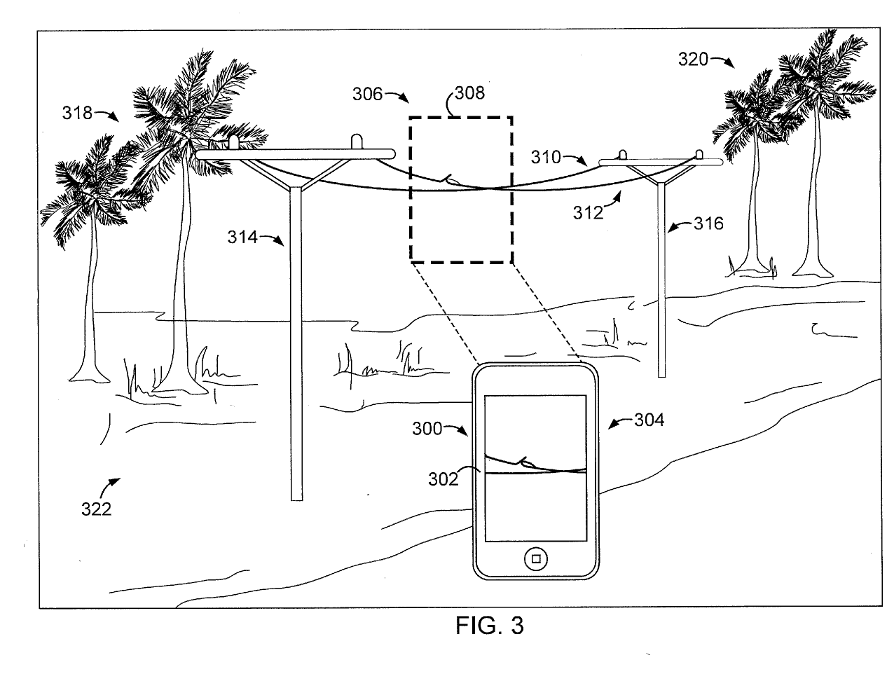

FIG. 3 illustrates an exemplary a client device 300, according to an embodiment. Client device 300 may, for example, take the form of any of the client devices described above in relation to FIGS. 1-2B. For example, the client device 300 may take the form of the client device 104 such that the I/O interface 302 may take the form of I/O interface 130 as described above in relation to FIG. 1.

As shown, the client device 300 may capture multimedia data 304 indicative of a repairable object 306. For example, the client device 300 may be a camera phone and/or a wearable computing device configured to capture the multimedia data 304. Further, the multimedia data 304 may include image data, thermal image data, sound data, and/or audiovisual data indicative of the repairable object 306, among other types of data indicative of the repairable object 306. In addition, as shown, the repairable object 306 may be repairable cable such as a telephone cable, a power cable, and/or an electric cable, among other types of objects that may be repaired. For example, repairable object 306 may be a repairable cable including one or more protective coatings stripping off of the metal portion of the cable.

In addition, the client device 300 may capture the multimedia data 304 of a field-of-view (FOV) 308. For example, the FOV 308 may include the repairable object 306 of a cable 312 and possibly another cable 310. Yet, in some instances, the FOV 308 may also include other portions of the cables 310 and 312, support structures 314 and 316, and trees 318 and 320, among other aspects of an environment 322 proximate to the client device 300. Further, the FOV 308 may be defined by a measurement in a spherical coordinate system. For example, the FOV 308 may be defined by a height, a width, an angular measurement, an altitude, and/or an azimuth, and/or other measurements and dimensions.

In some embodiments, the multimedia data 304 may be accessed by a server device. For example, referring back to the FIG. 1. The processing module 114 of the server device 102 may access the multimedia data 304 from client device 104. In some instances, the server device 102 may communicate with client device 104 via communication network 108 to receive the multimedia data 304, among other methods to access the multimedia data 304. Further, the server device 102 may request the client device 104 to send the multimedia data 304 and receive the multimedia data 304 in response to the request.

In some embodiments, the server device 102 may identify the repairable object 306 of the cable 312, and/or other types of repairable objects such as a building, a street, a sidewalk, a vehicle, one or more parts of the vehicle, a cable, a power line, a transformer, a pipe, a light, a sign, a signal, a leakage, and/or a puncture. For example, the multimedia data 304 may be combined with other forms of multimedia data of the repairable object 306 through image/photo stitching, pixel merging, and image overlapping, and/or other types of image processing schemes for combining the multimedia data 304. As such, various details of the broken line may be analyzed and inspected to identify damages that may require maintenance.

In some embodiments, the server device 102 may determine that the multimedia data 304 includes image data including the details of one or more damaged portions of repairable object 306 and location data indicating a location of the repairable object 306. Further, the diagnostics module 118 may select an entity to repair the object 306 based on the details of the damaged portions and/or the location of the repairable object 306. Yet further, the reporting module 120 may include in a report the details of the damaged portion and the location of the repairable object 306. In addition, the server device 102 may send the report and the details to the entity selected to repair the object 306.

In some embodiments, the diagnostics module 118 may further determine various aspects of the repairable object 306 from the image data. For example, the diagnostics module 118 may estimate from the image data a cause of the one or more damaged portions of the repairable object 306. In some instances, the diagnostics module 118 may determine the cause of the repairable object 306 is from a falling branch of the one or more trees 318 and 320. Further, the diagnostics module 118 may determine the cause to be from cable 312 wearing down over time possibly over time and/or due to weather, among other possible causes. Further, the reporting module 120 may include in a report an indication of the estimated cause, possibly to implement preventative measures to prevent and/or mitigate reoccurring causes.

In some embodiments, the diagnostics module 118 may determine from the image data an indication of an illumination associated with the repairable object 306. In particular, the illumination may be a spark, a flash, a glow, a flame, a fire, and/or a blaze, among other types of illuminations. For example, the diagnostics module 118 may identify the indication of the illuminations based on determining pixel brightness and/or intensities of the image data. As such, the reporting module 120 may include in the report the indication of the illumination and possibly the location of the illumination.

In some instances, the diagnostics module 118 may determining a level of the illumination the repairable object 306. For example, the diagnostics module 118 may determine the level of the illumination meets one or more illumination thresholds. In some instances, the illumination thresholds may be pre-determined thresholds to identify the severity of the illumination to be a spark as opposed to a fire, for example. Further, the diagnostics module 118 may select an entity to repair the repairable object 306 based at least on the level of the illumination that meets the illumination threshold. For example, the diagnostics module 118 may select the fire department based on the level of the illumination that meets the illumination threshold. As such, the report may be routed to the fire department based at least on the indication of a possible fire. In some instances, the report may also be routed to other entities equipped to handle, contain, and/or extinguish the spark and/or fire, possibly based on the cause of the spark and/or fire. For example, reports indicative of fires caused by chemicals, flammable substances, and/or other synthetic materials may be routed to chemical specialists of the fire department, containment teams, and/or other personnel trained and equipped to contain flammable hazards.

In some instances, the diagnostics module 118 may further determine an indication of a threat level based at least on the level of the illumination that meets the illumination threshold. For example, a spark around the repairable object 306 may indicate a moderate threat level and a fire around the repairable object 306 may indicate a high threat level. Further, the reporting module 120 may include in the report the indication of the threat level. As such, the fire department may prepare adequately to respond to the threat level. Further, the fire department may arrive at the scene 322 with proper tools to alleviate the fire around the repairable object 306.

In some embodiments, the diagnostics module 118 may analyze video data, image data, and/or audio data and determine instructions for the proper course of action to be taken. Further, the diagnostics module 118 may select the entity that the report should be routed based on the data and/or the instructions. For example, audio data corresponding to the repairable object may include a user recording, “the street is flooded due to a broken water piper, causing a traffic jam.” As such, the diagnostics module 118 may utilize voice recognition systems to decipher the words “flood” and “broken water pipe” and determine that the fire department and/or the city's water department may have the proper tools to remedy the broken water pipe. As such, the diagnostics module 118 may route the report to the fire department and/or the city's water department. In another example, image processing may indicate spraying water, which may result in a system determination of routing the image to the water department and/or fire department. In another example, infrared processing and/or image processing may indicate a fire from the image, which may result in a suggested or automatic routing of the image to the fire department.

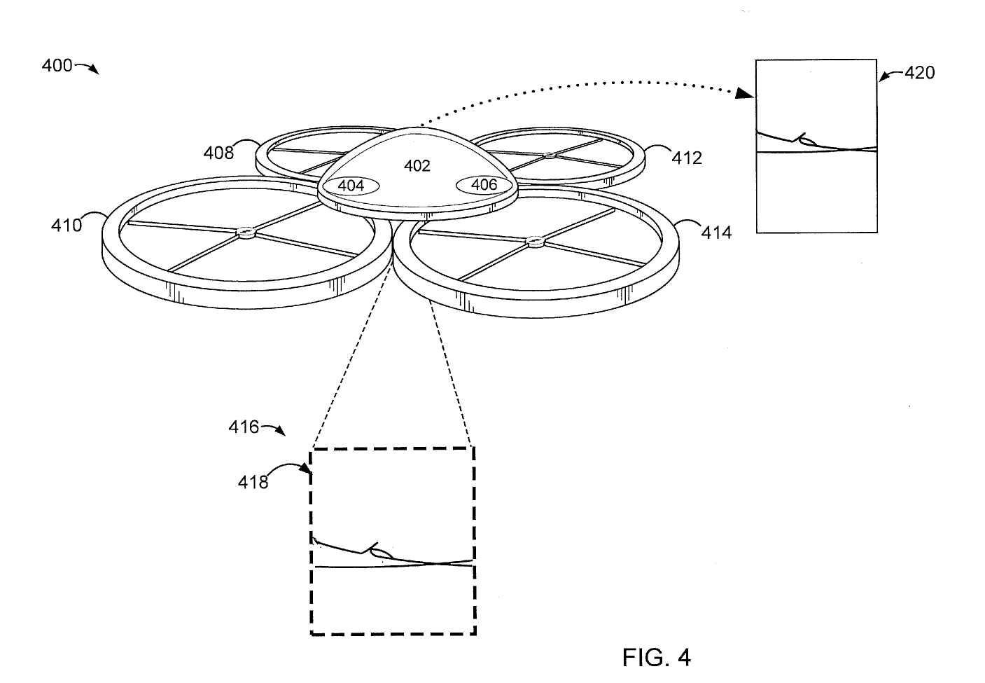

FIG. 4 illustrates another exemplary client device 400, according to an embodiment. The client device 400 may, for example, take the form of any of the client devices described above in relation to FIGS. 1-3. In some instances, the client device 400 may take the form of client device 104 described above in relation to FIGS. 1-3. Further, client device 400 may include a I/O interface 402, a communication interface 404, and a processor 406 that may take the form of I/O interface 130, a communication interface 132, and a processor 134 described above in relation to FIG. 1. In some instances, the client device 400 may be a drone device, a UAV device, a robotic device, a device capable of taking flight, and/or another type of mobile device capable of transmitting and/or receiving data.

As shown, client device 400, also possibly referred to as a drone device 400, may include motors 408, 410, 412, and 414. Each of the motors 408-412 may rotate and/or propel such that the drone device 400 may be lifted off a ground surface and into the air. In some instances, the drone device 400 may be configured to fly above structures, buildings, objects, and other aspects of a city or town. Further, each of the motors 408-412 may be controlled independently by navigation and altitude controls. For example, the drone device 400 may be controlled by client device 106 to fly above and/or around a repairable object 416 that may, for example, take the form of the repairable object 306 described above in relation to FIG. 3. Further, I/O interface 402 may extend to the bottom of the drone device 400 to capture multimedia data of the repairable object 416 located below the drone device 400.

In some instances, the drone device 400 may be configured to capture various views of a repairable object. In some instances, the drone device 400 may include a camera, a video camera, a thermal camera, an infrared camera, possibly similar to that of the camera phones described in relation to FIGS. 1-3. Further, the drone device 400 may include sensors such as heat sensors, capacitive sensors, proximity sensors, and/or other types of sensors to detect heat, various types of fires, and/or other details regarding fires. In some instance, referring back to FIG. 3, the drone device 400 may be configured to capture 360 degree-views of the repairable object 416. Further, the drone device 400 may be configured to capture aerial views of the repairable object 416.

As shown, the drone device 400 may capture multimedia data 420 of a field-of-view (FOV) 418. For example, the FOV 418 may be similar the FOV 308 described above in relation to FIG. 3. As such, the FOV 418 may include the repairable object 416 of a cable and possibly other proximately located cables. Further, the FOV 418 may include 360 degree-views of the repairable object 416. As shown, the FOV 418 may also include one or more aerial views of the repairable object 418. Further, the FOV 418 may be defined by a measurement in a spherical coordinate system from above the repairable object 418. For example, the FOV 418 may be defined by a height, a width, an angular measurement, an altitude, and/or an azimuth, and/or other measurements and dimensions from above the repairable object 418.

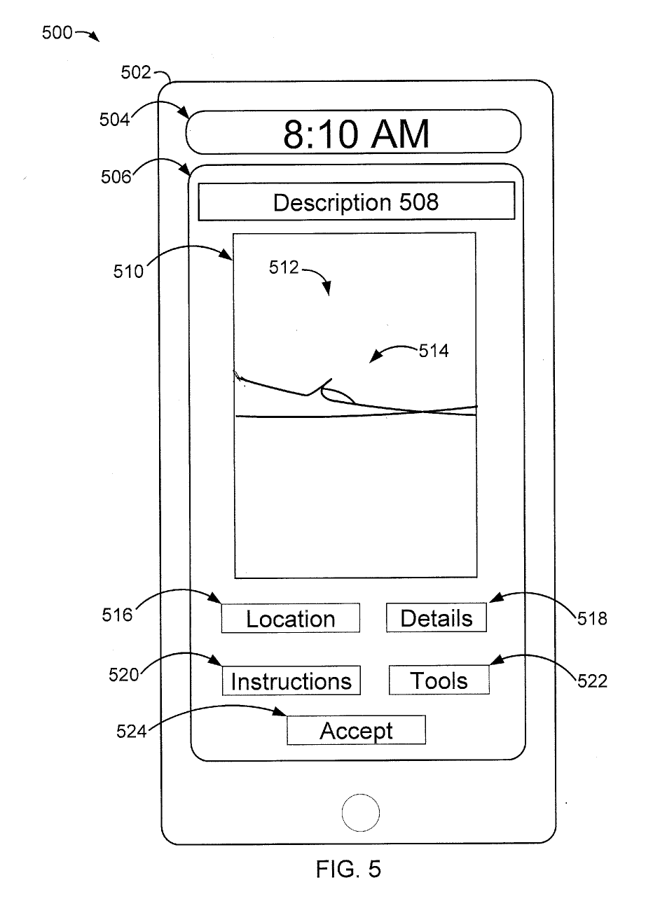

FIG. 5 illustrates yet another exemplary client device 500, according to an embodiment. The client device 500 may, for example, take the form of any of the client devices described above in relation to FIGS. 1-4. In some instances, the client device 500 may take the form of client device 106 described above in relation to FIGS. 1-4. For example, the client device 500 may provide an entity with instructions to repair an object.

As shown, client device 500 may include the I/O interface 502 that may take the form of I/O interface 140 described above in relation to FIG. 1. In some instances, the I/O interface 502 may display a time 504, possibly also indicating the time the client device 500 receives a report 506. Further, the I/O interface 502 may display the report 506 of a repairable object. Yet further, the I/O interface 502 may display a description 508 of a repairable object 512, possibly describing a “repairable cable,” e.g., a broken telephone and/or power cable. Yet further, the I/O interface 502 may display multimedia data 510 of a repairable object 512. For example, multimedia data 510 may take the form of the multimedia data 304 and/or 420 described above in relation to FIGS. 3 and 4, respectively. Yet further, the repairable object 512 may take the form of the repairable objects 306 and 416 described above in relation to FIGS. 3 and 4. In addition, the multimedia data 510 may display details of one or more damaged portions 514 of the repairable object 512.

In some instances, the I/O interface 502 may include touch inputs 516, 518, 520, 522, and 524. For example, a location input 516 may be selected to display an indication of the proximate location of the repairable object 512, possibly also indicating directions between a proximate location of the client device 500 and the proximate location of the repairable object 512. Further, a details input 518 may be selected to display details of the repairable object 512 such as, for example, the details of one or more damaged portions 514 of the repairable object 512. For example, the details may describe one or more protective coatings stripping off of the cable of the object 512, possibly exposing a metal portion of the cable. Yet further, an instructions input 520 may be selected to display instructions to repair the one or more damaged portions 514 of the repairable object 512. For example, the instructions may include instructions for replacing the cable of object 512 and/or covering the exposed metal portion of the cable. In addition, a tools input 522 may be selected to display the tools necessary to carry out the instructions for repairing the one or more damaged portions 514 of the repairable object 512. Yet further, an accept input 524 may be selected to send a reply to a server device indicating that the entity is accepting the task for repairing the object 512.

Referring back to FIGS. 1-4, the hardware modules/components 232-240 may execute instructions to perform operations. In some instances, the operations may include the processing module, e.g., the processing module 234, accessing data. For example, the processing module may access data from the one or more client devices, such as client device 104. Further, the operations may include processing module accessing first multimedia data 304 from a (first) client device of one or more client devices. Yet further, the operations may include the processing module accessing second multimedia data 420 from a (second) client device 400 of the one or more client devices. For example, the second multimedia data 420 may be accessed by the drone device 400 capturing a 360 degree view and/or an aerial view of the repairable object.

Further, the operations may include the diagnostics module, e.g., the diagnostics module 238, identifying details of the repairable object 512 from the multimedia data 510. Further, the operations may include diagnostics module identifying first details of the first multimedia data 510 and second details of the second multimedia data 420 possibly captured by the drone device 400. Yet further, the operations may include the diagnostics module combining the first details with the second details of the first multimedia data 510 and the second multimedia data 420, respectively. As noted, image/photo stitching, pixel merging, and image overlapping, among other types of image processing schemes may be used for combining the multimedia data 510 and 420.

In some embodiments, the multimedia data 510 may include audiovisual data that includes the details of the one or more damaged portions 514 of the repairable object 512. For example, the audiovisual data may include details of image data and sound data. In particular, the image data and/or the sound data may provide additional information related to the repairable object 512. Further, the operations may include the reporting module, e.g., the reporting module 240, determining the report 506 for the one or more entities to repair the one or more damaged portions 514 and including the audiovisual data in the report.

In some embodiments, the operations may further include identifying, by the processing module, e.g., the processing module 234, a drone device from the one or more client devices based at least on the audiovisual data. For example, the processing module may identify the audiovisual data includes aerial views of the repairable object 512 and determines that a drone device, such as the done device 400, captured the aerial views of the repairable object 512. Yet further, the operations may further include determining, by the diagnostics module, instructions indicative of a projected course for the drone device 400 to follow and additional details of the repairable object 512 for the drone device to record. For example, the additional details may include side-views and one or more aerial views of the repairable object 512. In addition the operations may further include sending, by the communications module, the instructions to the drone device 400.

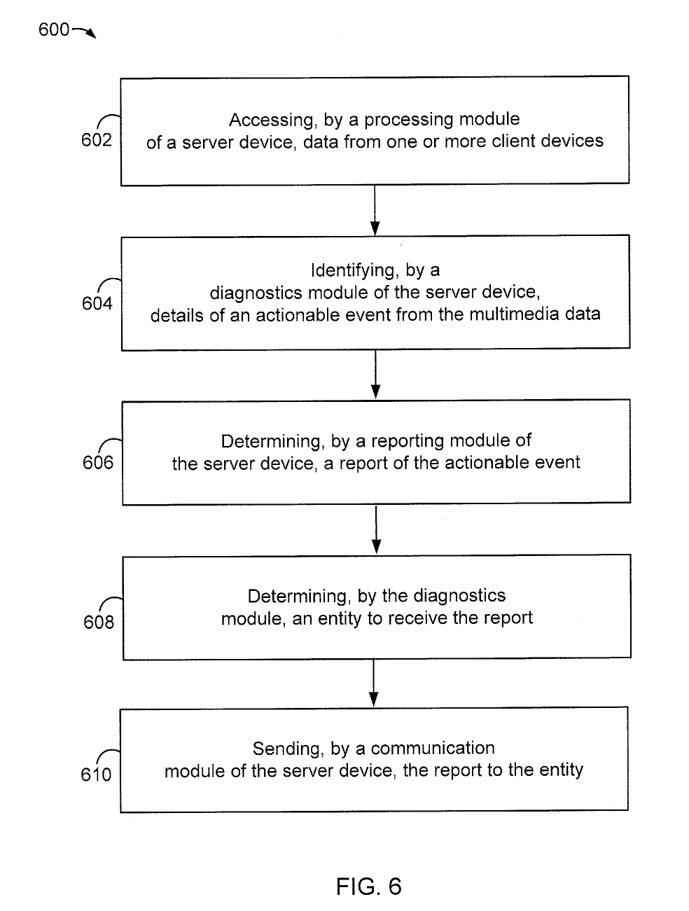

FIG. 6 is a flowchart of an exemplary method 600, according to an embodiment. Note that one or more steps, processes, and methods described herein may be omitted, performed in a different sequence, and/or combined for various types of applications.

At step 602, the method 600 may include accessing, by a processing module of a server device, data from one or more client devices, where the data includes multimedia data indicative of an actionable event, e.g., a hazardous event. Further, in some instances, the data may include location data indicative of a location of the actionable event. For example, referring back to FIGS. 1-2B, the processing module 234 may access data from the one or more client devices 104 and 106, where the data includes multimedia data indicative of an actionable event and/or location data indicative of the location of the actionable event.

At step 604, the method 600 may include identifying, by a diagnostics module of the server device, details of the actionable event from the multimedia data. For example, the diagnostics module 238 may identify details of the actionable event from the multimedia data. Further, the details may include the location, the environment, and/or the size of the actionable event, among other characteristics of the actionable event.

In some embodiments, the method 600 may include determining, by the diagnostics module, instructions to contain the actionable event, where the instructions include an indication of one or more tools required to carry out the instructions. For example, the diagnostics module 238 may determine the instructions to contain the actionable event, where the instructions include an indication of one or more tools required to carry out the instructions. Further, the instructions may include procedures to contain, enclose, quarantine, and/or isolate the actionable event, among other ways to stop the spread of the actionable event.

At step 606, the method 600 includes determining, by a reporting module of the server device, a report of the actionable event, where the report includes the location of the actionable event and the multimedia data indicative of the actionable event. In some instances, the report may also include the instructions to contain the actionable event. For example, the reporting module 240 may determine a report for an entity to contain the actionable event, where the report includes the instructions to contain, enclose, quarantine, and/or isolate the actionable event, among other ways to stop the spread of the actionable event.

At step 608, the method 600 may include determining, by the diagnostics module, an entity to receive the report. The entity may be determined in any manner described above in relation to FIGS. 1-5. For example, the entity may be selected based on skills, capabilities, tools, and/or equipment owned by the entity.

At step 610, the method 600 includes sending, by a communication module of the server device, the report to the entity. For example, the communication module 232 may send the report to the client device 106 proximately located to the entity.

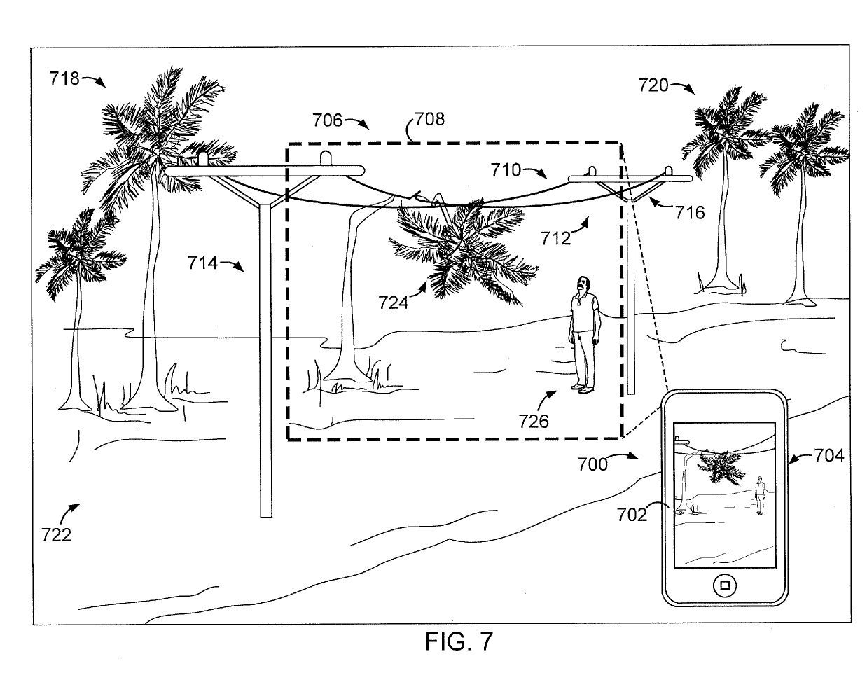

FIG. 7 illustrates yet another exemplary client device 700, according to an embodiment. Client device 700 may, for example, take the form of any of the client devices described above in relation to FIGS. 1-6. For example, client device 700 may take the form of client device 104 such that I/O interface 702 may take the form of I/O interface 130 as described above in relation to FIG. 1.

As shown, the client device 700 may capture multimedia data 704 indicative of an actionable event 706. For example, the client device 700 may be a camera phone and/or a wearable computing device configured to capture the multimedia data 704. Further, the multimedia data 704 may include image data, thermal image data, sound/audio data, and/or audiovisual data indicative of the actionable event 706, among other types of data indicative of the actionable event 706. In addition, as shown, the actionable event 706 may involve a falling tree limb 724 and a cable 712 such as a telephone cable, power cable, and/or an electric cable, among other types of cables. For example, actionable event 706 may include one or more damaged portions of the cable 712 caused by the falling tree limb 724.

In addition, the client device 700 may capture the multimedia data 704 of a field-of-view (FOV) 708 of the actionable event 706. For example, the FOV 708 may include the actionable event 706 of the cable 712 and possibly another cable 710. Yet, in some instances, the FOV 708 may also include other portions of the cables 710 and 712, support structures 714 and 716, and trees 718 and 720, the tree limb 724, among other aspects of an environment 722 proximate to the client device 700.

Referring back to FIG. 6, the method 600 may be implemented for containing the actionable event 706 described above in relation to FIG. 7. In some instances, the method 600 may include determining the entity to receive the report based on at least one of the multimedia data and/or a user input from one or more client devices, e.g., the client device 700. Further, the multimedia data 704 may include audiovisual data that includes the details of the actionable event 706. As such, one or more steps of the method 600 may be carried out to send a report of the actionable event 706 to one or more entities to contain the actionable event 706.

In some embodiments, the method 600 may also include determining, by the diagnostics module, that the details of the actionable event 706 indicate a flood, a volcanic eruption, an earthquake, a tsunami, a tornado, a storm, and/or a hurricane, among other events that may cause damages. For example, such events may cause the tree limb 724 to fall on the cable 712. Yet further, in some instances, the details of the actionable event 706 may indicate an animal, an infected animal, a diseased animal, a fire, nuclear waste exposed, a rescue event, and an event to help a human person 726, among other possible events. In some instances, the details of the actionable event 706 may indicate a cat stuck in a tree, a snake on the playground, an animal in the middle of a highway or road, and/or other events related to possible issues with animals.

In some embodiment, the method 600 may include determining, by the diagnostics module, that the details of the actionable event further indicate the human person 726 involved in the actionable event 706. Further, the reporting module determining the report of the actionable event 706 may involve including the indication of the human person 726 in the report. For example, the indication of the human person 726 may include details regarding the human person 726 such as the person's estimated age, size, dimensions, position and/or location with respect to the falling tree limb 724 and/or the cable 712. Further, the indication may include one or more conditions of the human person 726. In some instances, for example, the one or more conditions may include signs, symptoms, and/or other indicators of a cardiac arrest, a heart condition, a heart attack, and/or another condition regarding the human person 726. In some instances, the method 600 may include enabling the entity to rescue the human person 726 based at least on the location of the actionable event and the instructions in the report.

In some embodiments, the method 600 may include determining, by the diagnostics module, a threat level based at least on the indication of the human person 726 involved in the actionable event 706. For example, the threat level may be based on the location of human person 726 and the location of the falling tree limb 724 and/or the cable 712. Yet further, the threat level may be based on any estimated injuries of the human person 726 and/or the consciousness of the human person 726. Further, the reporting module may include the threat level in the report. It should be noted that various details of the actionable event 706 may be displayed on a client device similarly as described above in relation to FIG. 5.

In some embodiments, the method 600 may include identifying, by the processing module, a drone device, such as the drone device 400, from the one or more client devices 104-106 based at least on the audiovisual data. Further, the method 600 may include determining, by the diagnostics module, instructions indicative of a projected course for the drone device to follow and additional details of the actionable event 706 for the drone device to record. For example, the instructions may direct the drone device to capture additional details of the human person 726 and the environment 722 that may be harmful to the human person 726. In addition, the method 600 may include sending, by the communications module, the instructions to the drone device.

In some embodiments, the drone device may transport one or more tools, materials, gadgets, and/or other objects to the location of the actionable event 706. As noted, for example, the method 600 may include determining one or more conditions of the human person 726, possibly including symptoms of a heart condition and/or a heart attack. In such instances, the method 600 may include determining instructions for the drone device 400 to fly and carry a defibrillator to the human person 726. As such, one or more entities arriving to the scene/environment 722 and/or people proximate to the scene/environment 722 may utilize the defibrillator to revive the human person 726 during critical moments of the heart attack. In some instances, the method 600 may include providing instructions to use the defibrillator and reviving the human person 726. For example, referring back to FIG. 4, these instructions may be played through a speaker of the I/O interface 402 and/or displayed in the report shown on a graphic display of the I/O interface 402.

As noted, one or more of the entities carrying out the instructions, e.g., instruction for repairing an object and/or containing an actionable event, may have an account. Some examples of accounts may include financial accounts, e-mail accounts, social networking accounts, and/or accounts with service providers, among other possibilities. In some instances, the account may provide the entities with access to the reports such that the entities may carry out the instructions in the reports and receive compensation accordingly. For example, login information may be entered by the entity to authenticate the entity's account and payment information may be provided to the entity to compensate the entity for carrying out instructions. As such, an account may be a compilation of data that provides access to the reports through a reporting service.

In some embodiments, one or more entities with an account may be a person, a team of persons, and/or a corporation, among other possibilities. For example, an entity may be a corporation with access to a corporate account to repair objects and/or contain hazards, possibly by its employees and/or contractors. Yet further, an entity may be a computing device, a drone device, a computing system, a robotic system, and/or another form of technology capable of sending and receiving information using the account, for example, to repair an object and/or contain an actionable event. As noted, the entities may be trained, licensed, qualified, and/or certified to carry out the instructions to repair objects and/or contain actionable events.

In some embodiments, an account may be created by one or more entities using the reporting service. Further, an account may be generated by the reporting service and/or by other services. In some instances, the account may be created via applications, web sites, and/or other reporting services. In some embodiments, an account for a particular entity may include data related to the entity. Further, the entity may provide relevant information to the account for repairing objects and/or containing hazards. In some instances, an entity may provide to the account descriptions of services provided by the entity. Further the entity may provide descriptions of skills, capabilities, available tools and/or equipment, among other relevant information for repairing objects and containing actionable events. Yet further, the reporting service may gather data regarding the entity and compile the data into the entity's account. In particular, the reporting service may track prior objects repaired by the entity and/or actionable events contained by the entity, possibly indicative of future objects and/or events that the entity may be able repair and/or contain. Further, the reporting service may track how long the entity takes to repair an object and/or contain an actionable event such that the service may provide recommendations to interested parties.

In some embodiments, an entity may have a single account providing a representation of the entity via a reporting service among multiple other services, websites, applications, etc. For instance, an entity could opt to use their e-mail account or social network account as a common login for reporting services, among other online applications, which are provided by a number of different services. For example, the entity may use the account to search for objects to repair and/or events to contain. Further, the entity may select one or more tasks, e.g., objects to repair and/or actions to contain. In some instances, the entity may be prompted for login and/or authentication information and thereby submit the requisite information to search for these tasks. In addition, the entity may be prompted for payment and thereby submit the requisite information to receive compensation for accepting these tasks.

In some embodiments, a reporting system may include a server device. For example, a processing module of a server device may include means for accessing data packets from one or more client devices, where the data packets comprise multimedia data indicative of a repairable object. Further, a diagnostics module of the server device may include means for identifying from the multimedia data details of one or more damaged portions of the repairable object, where the diagnostics module further determines instructions to repair the one or more damaged portions, and where the diagnostics module has means for selecting an entity to repair the repairable object based at least on the details of the one or more damaged portions. Yet further, a reporting module of the server device may include means for determining a report for the entity selected to repair the repairable object, where the report comprises the details of the one or more damaged portions and the instructions to repair the one or more damaged portions. In addition, a communication module of the server device may include means for sending the report to a client device of the entity selected to repair the object.

The above description describes various features and functions of the disclosed systems, devices, mediums, and/or methods with reference to the accompanying figures. It should be readily understood that the aspects of the present disclosure, as generally described herein, and illustrated in the figures, can be arranged, substituted, combined, separated, and designed in a wide variety of different configurations, all of which may be contemplated herein.

With respect to any or all of the message flow diagrams, scenarios, and flow charts in the figures and as discussed herein, each step, block and/or communication may represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages may be executed out of order from that shown or discussed, including in substantially concurrent or in reverse order, depending on the functionality involved. Further, more or fewer steps, blocks and/or functions may be used with any of the message flow diagrams, scenarios, and flow charts discussed herein, and these message flow diagrams, scenarios, and flow charts may be combined with one another, in part or in whole.

A step or block that represents a processing of information may correspond to circuitry that can be configured to perform the specific logical functions of a herein-described method or technique. Alternatively or additionally, a step or block that represents a processing of information may correspond to a module, a segment, or a portion of program code (including related data). The program code may include one or more instructions executable by a processor for implementing specific logical functions or actions in the method or technique. The program code and/or related data may be stored on any type of computer-readable medium such as a storage device including a disk or hard drive or other storage media.

The computer-readable medium may also include non-transitory computer-readable media such as media that stores data for short periods of time like register memory, processor cache, and/or random access memory (RAM). The computer-readable medium may also include non-transitory computer-readable media such as media that may store program code and/or data for longer periods of time, such as secondary or persistent long term storage, like read-only memory (ROM), optical or magnetic disks, and/or compact-disc read only memory (CD-ROM), for example. Thus, various forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read. Moreover, a step or block that represents one or more information transmissions may correspond to information transmissions between software and/or hardware modules in the same physical device. Further, other information transmissions may be between software modules and/or hardware modules in different physical devices.

In various embodiments of the present disclosure, execution of instruction sequences to practice the present disclosure may be performed by a computer system. In various other embodiments of the present disclosure, a plurality of computer systems coupled by a communication link to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure and the accompanying figures may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The present disclosure, the accompanying figures, and the claims are not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A reporting system, comprising:
a processing module of a server device that accesses data packets from one or more client devices, wherein the data packets comprise multimedia data indicative of a repairable object;
a diagnostics module of the server device that identifies from the multimedia data details of one or more damaged portions of the repairable object, wherein the diagnostics module further determines instructions to repair the one or more damaged portions, and wherein the diagnostics module further selects an entity to repair the repairable object based at least on the details of the one or more damaged portions;
a reporting module of the server device that determines a report for the entity selected to repair the repairable object, wherein the report comprises the details of the one or more damaged portions and the instructions to repair the one or more damaged portions; and
a communication module of the server device that sends the report to a client device of the entity selected to repair the object.

2. The reporting system of claim 1, wherein the repairable object comprises at least one of the following: a building, a street, a sidewalk, a vehicle, one or more parts of the vehicle, a cable, a power line, a transformer, a pipe, a light, a sign, a signal, a leakage, and a puncture.

3. The reporting system of claim 1, wherein the multimedia data comprises image data including the details of the one or more damaged portions and location data of a location of the repairable object.

4. The reporting system of claim 3, wherein the diagnostics module further estimates from the image data a cause of the one or more damaged portions of the repairable object, and wherein the reporting module further includes in the report an indication of the estimated cause.

5. The reporting system of claim 3, wherein the diagnostics module further determines from the image data an indication of an illumination associated with the repairable object, and wherein the reporting module further includes in the report the indication of the illumination.

6. The reporting system of claim 5, wherein the diagnostics module further determines a level of the illumination meets an illumination threshold, and wherein the diagnostics module selects the entity to repair the reparable object based at least on the level of illumination that meets the illumination threshold.

7. The reporting system of claim 6, wherein the diagnostics module further determines an indication of a threat level based at least on the level of the illumination that meets the illumination threshold, and wherein the reporting module further includes in the report the indication of the threat level.

8. The reporting system of claim 1, wherein the one or more client devices includes a drone device, wherein the drone device is configured to capture one or more of a 360-degree view of the repairable object and an aerial view of the repairable object.

9. A non-transitory computer-readable medium having stored thereon machine-readable instructions that, when executed by hardware modules of a server device, cause performance of operations comprising:
accessing, by a processing module of the hardware modules, data from one or more client devices, wherein the data comprises multimedia data indicative of a repairable object;
identifying, by a diagnostics module of the hardware modules, details of the repairable object from the multimedia data, wherein the details indicate one or more damaged portions of the repairable object;
determining, by the diagnostics module, instructions to repair the one or more damaged portions, wherein the instructions comprise an indication of one or more tools required to carry out the instructions;
determining, by the reporting module, a report for one or more entities to repair the one or more damaged portions, wherein the report comprises the instructions to repair the one or more damaged portions; and
sending, by a communication module of the one or more hardware modules, the report to the entity.

10. The non-transitory computer-readable medium of claim 9, wherein the processing module accessing the data from the one or more client devices comprises:
the processing module accessing first multimedia data from a first client device of the one or more client devices; and
the processing module accessing second multimedia data from a second client device of the one or more client devices.

11. The non-transitory computer-readable medium of claim 10, wherein the diagnostics module identifying details of the repairable object from the multimedia data comprises:
the diagnostics module identifying first details of the first multimedia data and second details of the second multimedia data; and
the diagnostics module combining the first details with the second details.

12. The non-transitory computer-readable medium of claim 9, wherein the multimedia data comprises audiovisual data that includes the details of the one or more damaged portions of the repairable object.

13. The non-transitory computer-readable medium of claim 12, wherein the reporting module determining the report for the one or more entities to repair the one or more damaged portions comprises including the audiovisual data in the report.

14. The non-transitory computer-readable medium of claim 12, wherein the operations further include:
identifying, by the processing module, a drone device from the one or more client devices based at least on the audiovisual data;
determining, by the diagnostics module, instructions indicative of a projected course for the drone device to follow and additional details of the repairable object for the drone device to record; and
sending, by the communications module, the instructions to the drone device.

15. A method, comprising:
accessing, by a processing module of a server device, data from one or more client devices, wherein the data comprises multimedia data indicative of an actionable event and location data indicative of a location of the actionable event;
identifying, by a diagnostics module of the server device, details of the actionable event from the multimedia data;
determining, by a reporting module of the server device, a report of the actionable event, wherein the report comprises the location of the actionable event and the multimedia data indicative of the actionable event;
determining, by the diagnostics module, an entity to receive the report; and
sending, by a communication module of the server device, the report to the entity.

16. The method of claim 15, wherein determining the entity to receive the report is based on at least one of the multimedia data and a user input from the one or more client devices, and wherein the multimedia data comprises audiovisual data that includes the details of the actionable event, and wherein the audiovisual data comprises image data and audio data.

17. The method of claim 16, further comprising:
determining, by the diagnostics module, that the details of the actionable event indicate at least one of the following: an animal, an infected animal, a diseased animal, a fire, a flood, a volcanic eruption, an earthquake, a tsunami, a tornado, a storm, a hurricane, nuclear waste, a rescue event, and an event to help a human person.

18. The method of claim 16, further comprising:
determining, by the diagnostics module, that the details of the actionable event further indicate a human person involved in the actionable event, and wherein the reporting module determining the report of the actionable event comprises including the indication of the human person in the report; and
enabling the entity to rescue the human person based at least on the location of the actionable event.

19. The method of claim 18, further comprising:
determining, by the diagnostics module, a threat level based at least on the indication of the human person involved in the actionable event, and wherein the reporting module determining the report further comprises including the threat level in the report.

20. The method of claim 16, further comprising:
identifying, by the processing module, a drone device from the one or more client devices based at least on the audiovisual data;
determining, by the diagnostics module, instructions indicative of a projected course for the drone device to follow and additional details of the actionable event for the drone device to record; and
sending, by the communications module, the instructions to the drone device.
